(19) United States
(12) Patent Application Publication
(10) Pub. No.: US 2013/0135893 A1
(43) Pub. Date: May 30, 2013

(54) Light Bar Fixing Device, Backlight Module and LCD Device

(71) Applicant: Yanxue Zhang, Shenzhen (CN)

(72) Inventor: Yanxue Zhang, Shenzhen (CN)

(21) Appl. No.: 13/376,208

(22) PCT Filed: Dec. 2, 2011
(86) PCT No.: PCT/CN11/83340

§ 371 Date: Dec. 5, 2011

(30) Foreign Application Priority Data
Nov. 25, 2011 (CN) 201110382341.6

(51) Int. Cl. G09F 13/18; F21V 11/00; F21V 13/02; F21V 17/00

(52) U.S. Cl. 362/602; 362/634; 362/608; 362/617

(57) ABSTRACT

The present invention discloses a light bar fixing device, a backlight module and an LCD device. The light bar fixing device of the backlight module comprises a fixing structure for fixing a light guide plate of the backlight module respectively from three spatial dimensions. In the present invention, because the light guide plate is fixed on the light bar fixing device, the fixing device of the light guide plate is saved; moreover, the light guide plate is fixed to the light bar fixing device from three spatial dimensions, so that the omnibearing positioning of the light guide plate is achieved.

### TECHNICAL FIELD

The present invention relates to the field of liquid crystal displays, and more particularly to a light bar fixing device, a backlight module and a liquid crystal display (LCD) device.

### BACKGROUND

The LCD device comprises an LCD panel and a backlight module; the existing backlight module generally adopts an LED as a backlight source; because the LED can accumulate much heat for long-term work, a heat sink shall be erected. As shown in FIG. 1 and FIG. 2, in a side-emitting backlight module, the LED is distributed on the side surface of a light guide plate of the backlight module to form a light bar; considering dissipation and the fixation of the light bar, an aluminum extrusion press is generally adopted as the heat sink for fixing the light bar and achieving radiating design. In the side-emitting backlight module, the light guide plate shall be positioned comprehensively; thus, the positioning structure of the light guide plate is especially designed; not only the cost is increased, but also the positioning structure is further added, which is not beneficial to thinning of the backlight module.

As shown in FIG. 3, contrast file CN201129668Y discloses a light guide plate on 8 Oct. 2008. A fixing device of the light guide plate is used for respectively clamping the light guide plate from a light incident surface and a light emergent surface of the light guide plate; a groove is arranged in the middle position of the fixing device; the aluminum extrusion press which can be provided with the light bar is embedded into the fixing device and fixed. The fixing device integrates the functions of the fixation of the light guide plate and LED dissipation and simplifies the structure of the backlight module; however, the assembly of a clamping structure is complicated; moreover, there is no positioning effect in a direction parallel to the light guide plate.

### SUMMARY

The aim of the present invention is to provide a light bar fixing device with simple structure capable of reliably fixing a light guide plate, a backlight module and an LCD device.

The aim of the present invention is achieved by the following technical schemes.

A light bar fixing device of a backlight module comprises a fixing structure for fixing a light guide plate of the backlight module respectively from three spatial dimensions.

Preferably, the fixing structure comprises a lamp plate for fixing the light bar, a bottom plate which is connected with one end of the lamp plate and is used for fixing the bottom surface of the light guide plate, and a top plate which is connected with the other end of the lamp plate and is used for fixing the light emergent surface of the light guide plate; the bottom plate is provided with a baffle plate; the baffle plate is opposite to the lamp plate and is used for fixing the light incident surface of the light guide plate; both sides of the lamp plate are provided with side plates used for fixing both side surfaces of the light guide plate. This a concrete fixing structure, has a plurality of plate surfaces and has good spacing performance on the basis of original heat dispersion; in addition, for a traditional positioning structure of the light guide plate, the light guide plate needs cutting to form a given cooperative structure; moreover, in the technical proposal, the mode of fixing a plurality of plate surfaces is adopted without the need of cutting the light guide plate to achieve omnibearing reliable positioning and reducing the cutting cost of the light guide plate.

Preferably, the bottom plate covers the bottom surface of the light guide plate of the backlight module. A reflecting piece shall be arranged on the bottom surface of the light guide plate; if the bottom plate can cover the bottom surface of the light guide plate, the bottom plate can be used as the reflecting piece for further simplifying the structure.

Preferably, the lengths of the bottom plates and the top plate are not less than the length of the light incident surface of the light guide plate of the backlight module. The technical proposal ensures that the bottom plate and the top plate can completely cover the light leakage position of the light guide plate for effectively preventing light leakage.

Preferably, one surface of the top plate facing the light emergent surface of the light guide plate is provided with a reflecting coating; after the top plate is provided with the reflecting coating, the light leakage of the light bar can be reflected to the light guide plate for enhancing the light incident rate.

Preferably, there are two baffle plates which are respectively positioned in the corresponding positions of both sides of the lamp plate. In the positions of both sides of the lamp plate, the baffle plates can cover the light incident surface of the light guide plate without blocking the ray of the light bar from entering the light guide plate.

Preferably, the light bar is an LED light bar; the heights of the baffle plates are not more than the height of the minimum point of the LED; the plate surfaces of the baffle plates have the same height as the light emergent surface of the LED. This is an embodiment of adopting the LED as the backlight source. In the mode, the plate surfaces of the baffle plates have the same height as the light emergent surface of the LED; then, a non-coupling electrical distance is achieved between the light guide plate and the LED, which enhances the light incident rate; because the baffle plates are present, the LED will not be crushed even if the light guide plate is heated and expanded.

Preferably, the top plate is provided with an inwards concave groove; if the top plate is a plane, the resistance for embedding the light guide plate into the light bar fixing device is very large; not only the assemble is inconvenient, but also the surface of the light guide plate can be easily scraped; after the top plate is provided with the groove, in the processing of embedding the top plate, the top plate only comes into contact with the bottom surface of the groove so that the resistance is small and assembly and disassembly are convenient; the tight contact between the groove and the light guide plate can also be ensured through the action of elastic stress of the top plate without any influence on a fixing effect.

Preferably, an arcuated transition plate is arranged between the baffle plate and the side plate; the arcuated transition plate can protect the edge angle of the light guide plate and avoid wear caused by that the edge angle of the light guide plate comes into contact with other parts.

Preferably, the light bar fixing device is formed by cold stamping; because various components of the fixing device are formed in the cold stamping mode, the processing course can be simplified and the thinning can be achieved to the maximum extent.

Preferably, the light bar fixing device is an aluminum section; the aluminum section has good fixing strength and heat dispersion, which can fix the light guide plate and also enhance the radiating effect of the backlight module.

A backlight module comprises a light guide plate and the aforementioned light bar fixing device; the light bar fixing device comprises a light guide plate for fixing the backlight module from three spatial dimensions.

The light bar fixing device is used for fixing the light guide plate respectively from the light incident surface of the light guide plate of the backlight module, both sides adjacent to the surrounding of the light incident surface, the light emergent surface and the bottom surface opposite to the light emergent surface.

An LCD device comprises one of the backlight modules.

In the present invention, because the light guide plate is fixed on the light bar fixing device, the fixing device of the light guide plate is saved; moreover, the light guide plate is fixed to the light bar fixing device from three spatial dimensions, so that the omnibearing positioning of the light guide plate is achieved.

### BRIEF DESCRIPTION OF FIGURES

FIG. 1 is a schematic diagram of the existing backlight module;

FIG. 2 is a schematic diagram of one existing light bar fixing device;

FIG. 3 is a structural schematic diagram of a light guide plate in the prior art;

FIG. 4 is a schematic diagram of a backlight module in the present invention;

FIG. 5 is another schematic diagram of a backlight module in the present invention;

FIG. 6 is a schematic diagram of a light bar fixing device in the present invention;

FIG. 7 is another schematic diagram of a light bar fixing device in the present invention;

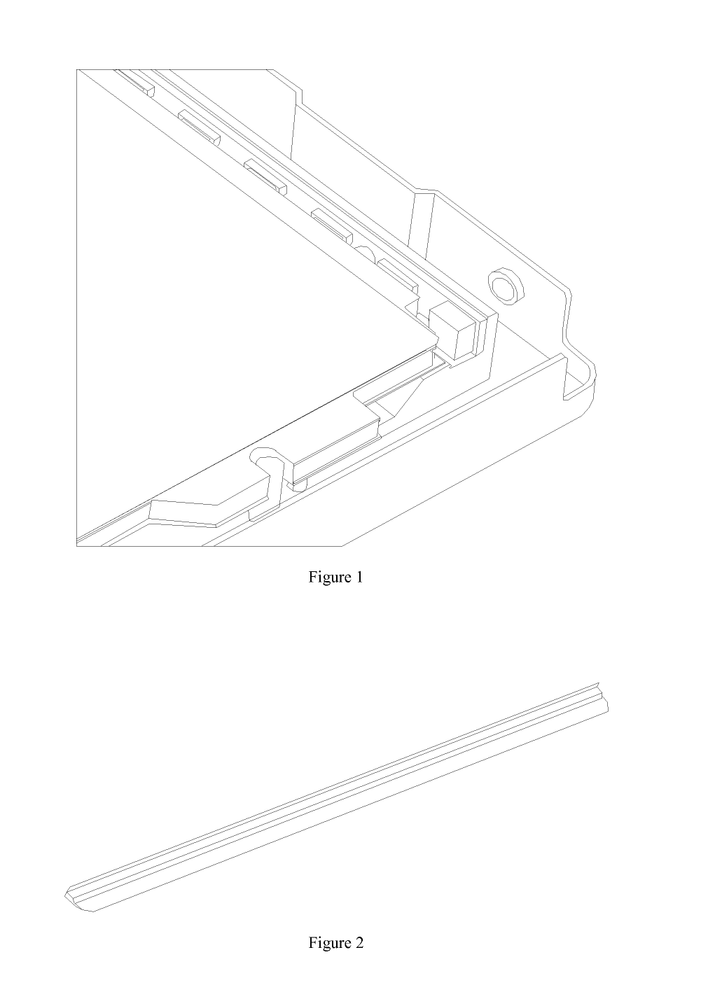

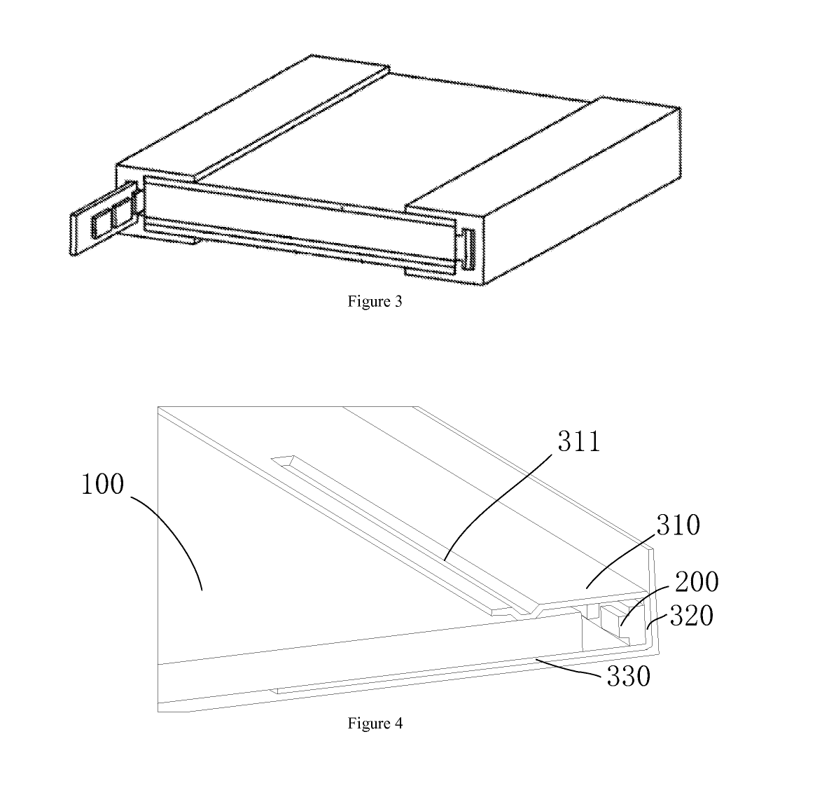

Wherein:
100. light guide plate;
200. LED light bar;
300. light bar fixing device;
310. top plate;
311. groove;
320. lamp plate;
330. bottom plate;
340. baffle plate;
350. side plate;
360. transition plate.

### DETAILED DESCRIPTION

The present invention will further be described in detail in accordance with the figures and the preferred examples.

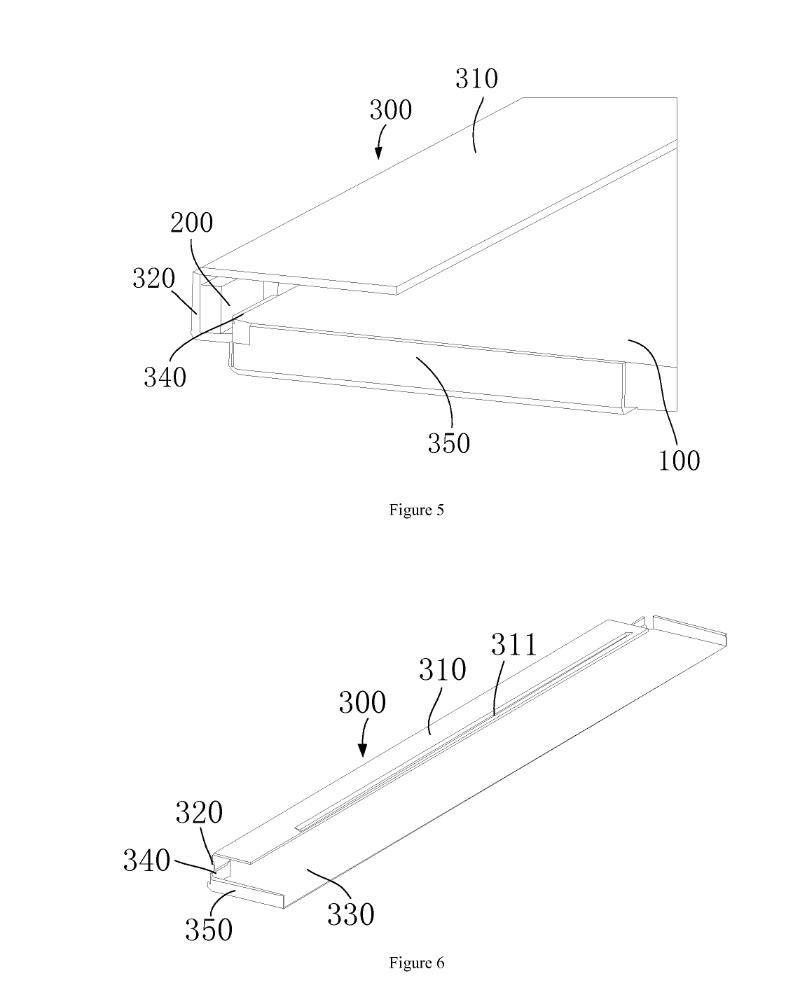

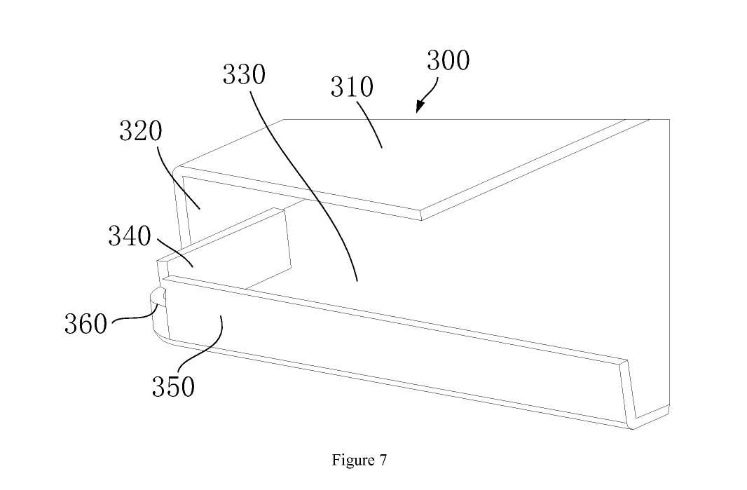

As shown in FIGS. 4 to 7, an LCD device comprises a backlight module; the backlight module comprises a light guide plate 100, an LED light bar 200 and a light bar fixing device 300; the light guide plate 100 is fixed on the light bar fixing device 300; the light bar fixing device 300 is provided with a fixing structure for fixing the light guide plate 100; the fixing structure comprises a lamp plate 320 for fixing the LED light bar 200, a bottom plate 330 connected with one end of the lamp plate 320, and a top plate 310 connected with the other end of the lamp plate 320; the bottom plate 330 is provided with a baffle plate 340 opposite to the lamp plate 320; side plates 350 are arranged on both sides of the lamp plate 320; an arcuated transition plate 360 is also arranged between the baffle plate and the side plate.

The baffle plate 340 restricts the light incident surface of the light guide plate 100 of the backlight module; the side plate 350 restricts side surfaces on both sides of the light incident surface (wherein the side plate 350 on one side of the light guide plate is not shown in FIG. 4); the top plate 310 restricts the light emergent surface of the light guide plate 100; the bottom plate 330 restricts the bottom surface of the light guide plate 100 opposite to the light emergent surface.

Wherein the lengths of the bottom plate 330 and the top plate 310 are not less than the length of the light incident surface of the light guide plate 100 of the backlight module. The bottom plate 330 even can cover the bottom surface of the whole light guide plate. One surface of the top plate 310 facing the light guide plate 100 is concave to form a strip-shaped groove 311; this surface is also provided with a reflecting coating. There are two baffle plates 340 which are respectively positioned in the corresponding positions of both sides of the lamp plate 320; the heights of the baffle plates 340 are not more than the height of the minimum point of the LED; the plate surfaces of the baffle plates 340 have the same height as the light emergent surface of the LED; then, a non-coupling electrical distance is achieved between the light guide plate 100 and the LED, which enhances the light incident rate; because the baffle plates 340 are present, the LED will not be crushed even if the light guide plate 100 is heated and expanded.

Further, the light bar fixing device 300 is formed by cold stamping of the aluminum section.

In the present invention, because the light guide plate 100 is fixed on the light bar fixing device 300, the fixing device of the light guide plate 100 is saved; moreover, the light incident surface, the side surface, the bottom surface and the light emergent surface of the light guide plate 100 are all fixed on the light bar fixing device 300, so that the omnibearing positioning of the light guide plate 100 is achieved. After the light bar fixing device 300 and the light incident surface, the side surface, the bottom surface and the light emergent surface of the light guide plate 100 are fixed, a relatively closed space is formed in the middle (which can be observed from a schematic diagram where one side plate is omitted in FIG. 4); the light bar is positioned in the space for effectively avoiding light leakage so as to enhance the light efficiency; then, a corresponding reflecting structure is saved and the structure of the backlight module is further simplified.

The present invention is described in detail in accordance with the above contents with the specific preferred examples. However, this invention is not limited to the specific examples. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A light bar fixing device of a backlight module, comprising: a fixing structure for fixing a light guide plate of the backlight module respectively from three spatial dimensions.

2. The light bar fixing device of the backlight module of claim 1, wherein said fixing structure comprises a lamp plate for fixing the light bar, a bottom plate which is connected with one end of said lamp plate and is used for fixing the bottom surface of said light guide plate, and a top plate which is connected with the other end of said lamp plate and is used for fixing the light emergent surface of said light guide plate; said bottom plate is provided with a baffle plate; said baffle plate is opposite to said lamp plate and is used for fixing the light incident surface of said light guide plate; both sides of said lamp plate are provided with side plates used for fixing both side surfaces of said light guide plate.

3. The light bar fixing device of the backlight module of claim 2, wherein said bottom plate covers the bottom surface of the light guide plate of said backlight module.

4. The light bar fixing device of the backlight module of claim 2, wherein the lengths of the bottom plates and the top plate are not less than the length of the light incident surface of the light guide plate of said backlight module.

5. The light bar fixing device of the backlight module of claim 4, wherein one surface of said top plate facing the light emergent surface of the light guide plate is provided with a reflecting coating.

6. The light bar fixing device of the backlight module of claim 2, wherein there are two baffle plates; said baffle plates are respectively positioned in the corresponding positions of both sides of the lamp plate.

7. The light bar fixing device of the backlight module of claim 2, wherein said light bar is an LED light bar; the heights of said baffle plates are not more than the height of the minimum point of the LED; the plate surfaces of said baffle plates have the same height as the light emergent surface of said LED.

8. The light bar fixing device of the backlight module of claim 2, wherein said top plate is provided with an inwards concave groove.

9. The light bar fixing device of the backlight module of claim 2, wherein an arcuated transition plate is arranged between said baffle plate and said side plate.

10. The light bar fixing device of the backlight module of claim 2, wherein said light bar fixing device is formed by cold stamping.

11. A backlight module, comprising: a light guide plate and the light bar fixing device of claim 1; said light bar fixing device comprises a fixing structure for fixing the light guide plate of said backlight module from three spatial dimensions.

12. The backlight module of claim 11, wherein said fixing structure comprises a lamp plate for fixing the light bar, a bottom plate which is connected with one end of said lamp plate and is used for fixing the bottom surface of said light guide plate, and a top plate which is connected with the other end of said lamp plate and is used for fixing the light emergent surface of said light guide plate; said bottom plate is provided with a baffle plate; said baffle plate is opposite to said lamp plate and is used for fixing the light incident surface of said light guide plate; both sides of said lamp plate are provided with side plates used for fixing both side surfaces of said light guide plate.

13. The backlight module of claim 12, wherein said bottom plate covers the bottom surface of the light guide plate of said backlight module.

14. The backlight module of claim 12, wherein the lengths of said bottom plate and said top plate are not less than the length of the light incident surface of the light guide plate of said backlight module.

15. The backlight module of claim 14, wherein one surface of said top plate facing the light emergent surface of the light guide plate is provided with a reflecting coating.

16. The backlight module of claim 12, wherein there are two baffle plates; said baffle plates are respectively positioned in the corresponding positions of both sides of the lamp plate.

17. The backlight module of claim 12, wherein said light bar is an LED light bar; the heights of said baffle plates are not more than the height of the minimum point of the LED; the plate surfaces of said baffle plates have the same height as the light emergent surface of said LED.

18. The backlight module of claim 12, wherein said top plate is provided with an inwards concave groove.

19. The backlight module of claim 12, wherein an arcuated transition plate is arranged between said baffle plate and said side plate.

20. The backlight module of claim 12, wherein said light bar fixing device is formed by cold stamping.

21. The backlight module of claim 11, wherein said light bar fixing device is used for fixing the light guide plate respectively from the light incident surface of the light guide plate of the backlight module, both sides adjacent to the surrounding of the light incident surface, the light emergent surface and the bottom surface opposite to the light emergent surface.

22. An LCD device, comprising: the backlight module of claim 11; said backlight module comprises a light guide plate and a light bar fixing device; said light bar fixing device comprises a fixing structure for fixing the light guide plate of said backlight module from three spatial dimensions.

23. The LCD device of claim 22, wherein said fixing structure comprises a lamp plate for fixing the light bar, a bottom plate which is connected with one end of said lamp plate and is used for fixing the bottom surface of said light guide plate, and a top plate which is connected with the other end of said lamp plate and is used for fixing the light emergent surface of said light guide plate; said bottom plate is provided with a baffle plate; said baffle plate is opposite to said lamp plate and is used for fixing the light incident surface of said light guide plate; both sides of said lamp plate are provided with side plates used for fixing both side surfaces of said light guide plate.

24. The LCD device of claim 23, wherein said bottom plate covers the bottom surface of the light guide plate of said backlight module.

25. The LCD device of claim 23, wherein the lengths of said bottom plate and said top plate are not less than the length of the light incident surface of the light guide plate of said backlight module.

26. The LCD device of claim 25, wherein one surface of said top plate facing the light emergent surface of the light guide plate is provided with a reflecting coating.

27. The LCD device of claim 23, wherein there are two baffle plates; said baffle plates are respectively positioned in the corresponding positions of both sides of the lamp plate.

28. The LCD device of claim 23, wherein said light bar is an LED light bar; the heights of said baffle plates are not more than the height of the minimum point of said LED; the plate surfaces of said baffle plates have the same height as the light emergent surface of said LED.

29. The LCD device of claim 23, wherein said top plate is provided with an inwards concave groove.

30. The LCD device of claim 23, wherein an arcuated transition plate is arranged between said baffle plate and said side plate.
